(19) United States
(12) Patent Application Publication
(10) Pub. No.: US 2023/0318358 A1
(43) Pub. Date: Oct. 5, 2023

(54) WIRELESS POWER TRANSMITTER AND METHOD FOR CONTROLLING WIRELESS POWER TRANSMITTER

(71) Applicant: SAMSUNG ELECTRONICS CO., LTD., Suwon-si (KR)

(72) Inventors: Yeeun CHOI, Suwon-si (KR); Harkjoon KIM, Suwon-si (KR); Hyunsu PARK, Suwon-si (KR); Seokyoung KANG, Suwon-si (KR); Sungku YEO, Suwon-si (KR); Eunha CHOI, Suwon-si (KR)

(21) Appl. No.: 18/208,210

(22) Filed: Jun. 9, 2023

Related U.S. Application Data
(63) Continuation of application No. PCT/KR2021/014510, filed on Oct. 18, 2021.

(30) Foreign Application Priority Data
Dec. 17, 2020 (KR) 10-2020-0177086

(51) Int. Cl. H02J 50/12; H02J 50/80; H02J 50/00

(52) U.S. Cl. CPC H02J 50/12; H02J 50/80; H02J 50/005

(57) ABSTRACT

A wireless power transmitter capable of selecting a master wireless power receiver to visually provide, to a user, states-of-charge of wireless power receivers being charged includes a coil, a short-range communication module for communicating with a plurality of the wireless power receivers receiving power from the coil, and a processor communicatively coupled to the short-range communication module. The processor detects a first wireless power receiver which has an inclination or a tilt or takes a preset motion from among the plurality of wireless power receivers, identifies the first wireless power receiver as a master wireless power receiver indicating states-of-charge of the plurality of wireless power receivers, and transmits, to the first wireless power receiver, a signal informing that the first wireless power receiver is identified as the master wireless power receiver.

### CROSS-REFERENCE TO RELATED APPLICATION(S

This application is a continuation application, claiming priority under § 365(c), of International Application No. PCT/KR2021/014510, filed on Oct. 18, 2021, which is based on and claims the benefit of Korean patent application number 10-2020-0177086 filed on Dec. 17, 2020, in the Korean Intellectual Property Office, the disclosures of which are incorporated by reference herein in their entireties.

### TECHNICAL FIELD

The disclosure relates to a wireless power transmitter and method for controlling the wireless power transmitter, which is capable of supplying wireless power to a plurality of wireless receivers.

### BACKGROUND ART

A technology to supply wireless power has recently been developed and applied to many electronic devices. Electronic devices employing the wireless power transmission technology do not require direct connection with a charging connector but may wirelessly receive power.

For the wireless power transmission technology, there are magnetic induction methods and magnetic resonance methods. Magnetic induction methods typically use magnetic induction between primary and secondary coils for wireless power transmission. Magnetic resonance methods typically use resonance for wireless power transmission by designing the primary and secondary coils to have the same resonant frequency.

In the case of the wireless power transmission technology based on the magnetic resonance methods, one resonant coil may be used to charge a plurality of electronic devices.

### DISCLOSURE

### Technical Problem

The disclosure provides a wireless power transmitter and method for controlling the wireless power transmitter, by which the wireless power transmitter that supplies power to a plurality of wireless power receivers may select one wireless power receiver to visually provide the user with states of charge of all or at least some of the wireless power receivers being charged.

The disclosure also provides a wireless power transmitter and method for controlling the wireless power transmitter by which the wireless power transmitter that supplies power to a plurality of wireless power receivers may select one wireless power receiver to receive a user input. This allows for an allocation of charging priorities to one or more of the wireless power receivers being charged.

### Technical Solution

According to an embodiment, a wireless power transmitter includes a plate, a resonant coil, a short-range communication module configured to communicate with a plurality of wireless power receivers which receive power from the resonant coil, and a processor. The processor is communicatively coupled with the short-range communication module. The processor is configured to detect a first wireless power receiver having an inclination or a tilt to the plate or makes a preset motion above the plate among the plurality of wireless power receivers, identify the first wireless power receiver as a master wireless power receiver to indicate states of charge of other ones of the plurality of wireless power receivers, and send the first wireless power receiver a signal indicating that the first wireless power receiver is identified as the master wireless power receiver.

The processor may receive information about amounts of received power of the plurality of wireless power receivers, and determine a coupling coefficient value between each of the plurality of wireless power receivers and the resonant coil based on the amounts of received power of the plurality of wireless power receivers and an amount of transmitted power of the resonant coil.

The processor may detect the first wireless power receiver in response to a coupling coefficient value between the first wireless power receiver and the resonant coil being within a preset range.

The processor may detect the first wireless power receiver in response to a coupling coefficient value between the first wireless power receiver and the resonant coil being maintained at a preset value or less for a preset period of time.

The processor may detect the first wireless power receiver in response to a coupling coefficient value between the first wireless power receiver and the resonant coil changing being in a preset pattern.

The processor may receive inclination information of the plurality of wireless power receivers, and detect the first wireless power receiver based on the inclination information of the plurality of wireless power receivers.

The processor may send information about a state of charge of each of the plurality of wireless power receivers to the master wireless power receiver.

The processor may receive information about priorities of the plurality of wireless power receivers from the master wireless power receiver, calculate required power for each of plurality of wireless power receivers based on the priority information, and send information about the calculated required power to each of the plurality of wireless power receivers.

The processor may obtain information about priorities of the plurality of wireless power receivers from the master wireless power receiver, and control transmission power of the resonant coil based on the priority information.

The processor may send information indicating that there is no other wireless power receiver being charged to the master wireless power receiver based on a fact that there is no wireless power receiver receiving power through the resonant coil except for the master wireless power receiver.

The processor may send information about an operational state of a controllable wireless power receiver among the plurality of wireless power receivers to the master wireless power receiver.

The processor may, when a second wireless power receiver has an inclination or a tilt to the plate or makes a preset motion above the plate is detected after the first wireless power receiver is detected, identify a wireless power receiver having a display of a larger size as the master wireless power receiver among the first wireless power receiver and the second wireless power receiver.

The processor may, when a second wireless power receiver has an inclination to the plate or makes a preset motion above the plate is detected after the first wireless power receiver is detected, receive location information of a user from the first wireless power receiver and the second wireless power receiver, and identify a wireless power receiver located closer to the user as the master wireless power receiver among the first wireless power receiver and the second wireless power receiver.

The processor may, when a second wireless power receiver has an inclination to the plate or makes a preset motion above the plate is detected after the first wireless power receiver is detected, identify the first wireless power receiver associated with a first user as a first master wireless power receiver for indicating a state of charge of a wireless power receiver associated with the first user among the plurality of wireless power receivers, and identify the second wireless power receiver associated with a second user as a second master wireless power receiver for indicating a state of charge of a wireless power receiver associated with the second user among the plurality of wireless power receivers.

The processor may send information about a state of charge of a wireless power receiver associated with the first user to the first master wireless power receiver, and send information about a state of charge of a wireless power receiver associated with the second user to the second master wireless power receiver.

The processor may send the first wireless power receiver a signal indicating that a position as the master wireless power receiver is finished in response to a second wireless power receiver identified as the master wireless power receiver after the first wireless power receiver is identified as the master wireless power receiver.

The processor may identify the first wireless power receiver as the master wireless power receiver even based on the first wireless power receiver determined as not being inclined to the plate, after the first wireless power receiver is identified as the master wireless power receiver.

The processor may transmit, to a second wireless power receiver, a command signal to provide an interface for designating the second wireless power receiver as the master wireless power receiver in response to establishment of communication connection with the second wireless power receiver through the short-range communication module, receive a first signal transmitted from the second wireless power receiver, and identify the second wireless power receiver as the master wireless power receiver in response to receiving the first signal, wherein the first signal is transmitted in response to the second wireless power receiver receiving a user input to designate the second wireless power receiver as the master wireless power receiver.

According to an embodiment, a method of controlling a wireless power transmitter includes detecting a first wireless power receiver being inclined to a plate or making a preset motion above the plate among a plurality of wireless power receivers receiving power from a resonant coil, identifying the first wireless power receiver as a master wireless power receiver to indicate states of charge of the plurality of wireless power receivers, and sending the first wireless power receiver a signal indicating that the first wireless power receiver is identified as the master wireless power receiver.

The detecting of the wireless power receiver may include receiving information about amounts of received power of the plurality of wireless power receivers, determining coupling coefficient values between the plurality of wireless power receivers and the resonant coil based on the amounts of received power of the plurality of wireless power receivers and an amount of transmitted power of the resonant coil, and detecting the first wireless power receiver based on the coupling coefficient values.

According to an embodiment, a wireless power transmitter can include a coil, a communication module configured to communicate with wireless power receivers which receive power from the coil and a processor. The processor is communicatively coupled with the communication module. The processor is configured to detect a first wireless power receiver being inclined or making a preset motion among the wireless power receivers, identify the first wireless power receiver as a master wireless power receiver to indicate states of charge of the wireless power receivers, and send the first wireless power receiver a signal indicating that the first wireless power receiver is identified as the master wireless power receiver.

According to an embodiment a method of controlling a wireless power transmitter includes recognizing that wireless power receivers receive power from a coil, detecting that a portion of the wireless power receivers are inclined or are making a preset motion, identifying each wireless power receiver of the portion as a master wireless power receiver to indicate states of charge of the wireless power receivers, and sending each wireless power receiver of the portion a signal indicating that each wireless power receiver of the portion is identified as the master wireless power receiver.

### Advantageous Effects

A wireless power transmitter may automatically select a wireless power receiver that is easy to provide visual indications for the user, allowing the user to easily check states of charge of wireless power receivers being charged.

The wireless power transmitter may set charging priorities of the wireless power receivers by reflecting the intention of the user.

### DESCRIPTION OF DRAWINGS

FIG. 1 is a perspective exterior view of a wireless power transmitter according to an embodiment.

FIG. 2 is a perspective interior view of a wireless power transmitter according to an embodiment.

FIG. 3 is a control block diagram of a wireless power transmitter according to an embodiment.

FIG. 4 illustrates configurations of a wireless power transmitter and a wireless power receiver according to an embodiment.

FIG. 5 is a flowchart illustrating an example in which a wireless power transmitter identifies a master wireless power receiver according to an embodiment.

FIG. 6 is a perspective view illustrating an occasion when there is a wireless power receiver having an inclination to a plate of a wireless power transmitter according to an embodiment.

FIGS. 7 and 8 are perspective views illustrating an example in which the user makes a preset motion with a wireless power receiver on a plate of a wireless power transmitter according to an embodiment.

FIG. 9 illustrates an example in which a wireless power transmitter transmits a command signal to provide an interface for designating a master wireless power receiver according to an embodiment.

FIGS. 10 and 11 are perspective views illustrating an occasion when there are multiple wireless power receivers having inclinations to a plate of a wireless power transmitter according to an embodiment.

FIG. 12 is a perspective view illustrating an occasion when a plurality of wireless power receivers having inclinations to a plate of a wireless power transmitter are associated with different users according to an embodiment.

FIG. 13 is a sequence chart illustrating an example of operations of a wireless power transmitter and a master wireless power receiver according to an embodiment.

FIG. 14 illustrates an example in which a master wireless power receiver identified by a wireless power transmitter provides a visual indication of states of charge of wireless power receivers being charged according to an embodiment.

FIG. 15 illustrates an example in which a master wireless power receiver identified by a wireless power transmitter provides an interface for setting priorities according to an embodiment.

FIG. 16 is a table illustrating an example in which a master wireless power receiver identified by a wireless power transmitter calculates required power according to priorities according to an embodiment.

FIG. 17 illustrates an example of an application executed by a master wireless power receiver while there is no wireless power receiver that receives power through a wireless power transmitter except for the master wireless power receiver according to an embodiment.

FIG. 18 is a flow diagram illustrating a method of controlling a wireless power transmitter according to an embodiment.

### MODES OF THE INVENTION

Embodiments and features as described and illustrated in the disclosure are merely examples, and there may be various modifications replacing the embodiments and drawings at the time of filing this application.

The terminology used herein is for the purpose of describing particular embodiments only and is not intended to limit the disclosure.

For example, the singular forms “a”, “an” and “the” as herein used are intended to include the plural forms as well, unless the context clearly indicates otherwise.

The terms “comprises” and/or “comprising,” when used in this specification, represent the presence of stated features, integers, steps, operations, elements, components or combinations thereof, but do not preclude the presence or addition of one or more other features, integers, steps, operations, elements, components, or combinations thereof.

The term including an ordinal number such as “first”, “second”, or the like is used to distinguish one component from another and does not restrict the former component.

Furthermore, the terms, such as “˜part”, “˜block”, “˜member”, “˜module”, etc., may refer to a unit of handling at least one function or operation. For example, the terms may refer to at least one process handled by hardware such as a field-programmable gate array (FPGA)/application specific integrated circuit (ASIC), etc., software stored in a memory, or at least one processor.

An embodiment of the disclosure will now be described in detail with reference to accompanying drawings. Throughout the drawings, like reference numerals or symbols refer to like parts or components.

The working principle and embodiments of the disclosure will now be described with reference to accompanying drawings.

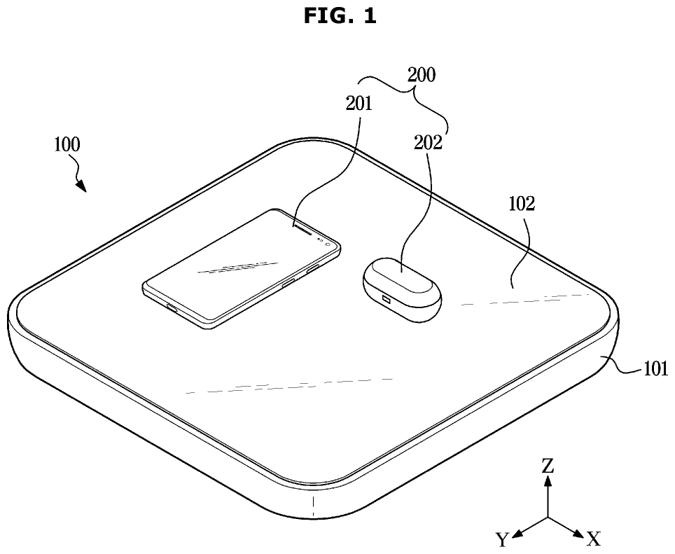

FIG. 1 is a perspective exterior view of a wireless power transmitter, according to an embodiment.

Referring to FIG. 1, a wireless power transmitter 100 includes a main body 101 that defines an exterior of the wireless power transmitter 100 and has various components of the wireless power transmitter 100 installed therein.

Many different electronic devices 201, 202 (collectively 200) may be placed on the main body 101. The electronic device 200 may refer to any wireless power receiver capable of wirelessly receiving power from the wireless power transmitter 100. For example, the electronic device 200 according to various embodiments of the disclosure may be various types of devices. The electronic device 200 may include or be provided as, for example, a portable communication device (e.g., a smartphone), a computer device, a portable multimedia device, a portable medical device, a camera, a wearable device, or a home appliance. The electronic device 200 according to embodiments of the disclosure is not limited to the aforementioned devices.

A plate 102 having a flat shape on which the electronic device 200 may be placed may be arranged on a top or a bottom or a major surface of the main body 101.

The electronic devices capable of receiving wireless power will now be collectively called a wireless power receiver, for convenience of explanation.

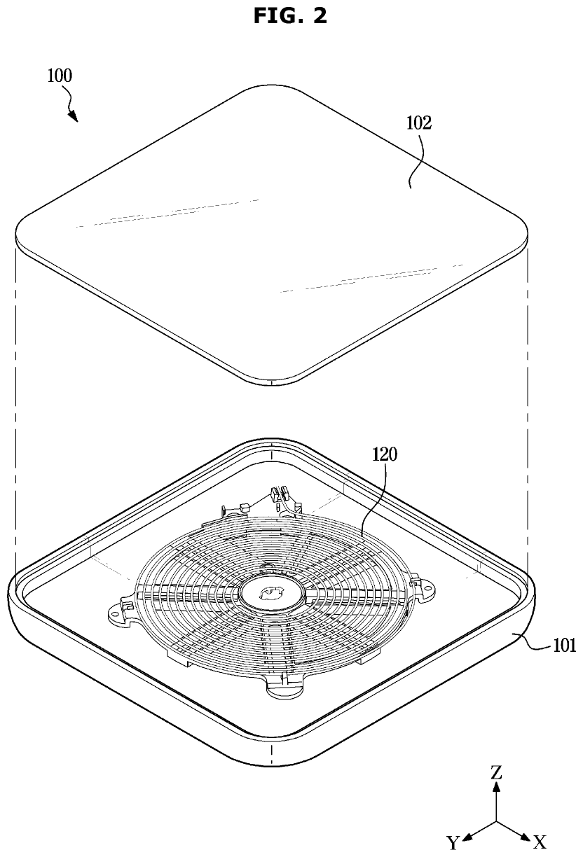

FIG. 2 is a perspective interior view of a wireless power transmitter according to an embodiment.

Referring to FIG. 2, a resonant coil 120 may be arranged under the plate 102 to provide wireless power to the wireless power receiver 200.

The resonant coil 120 may receive a driving current to produce radio waves or vibrations at a particular frequency. For example, the resonant coil 120 may include electric wires wound helically or spirally. For example, the resonant coil 120 may be formed in a helical structure in which electric wires are almost equidistantly positioned around a center axis or in a spiral structure in which electric wires are positioned in the same plane around a center point.

In this case, the resonant coil 120 may be arranged on a plane parallel to the plate 102.

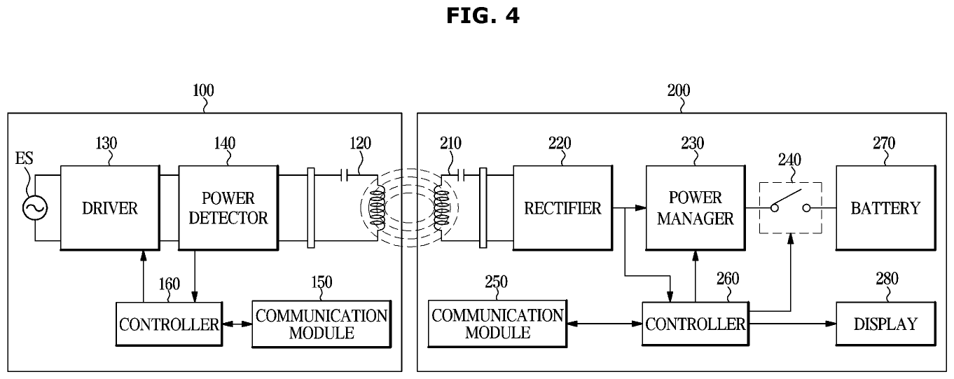

The resonant coil 120 may transmit wireless power through magnetic coupling with a receive coil 210 that is included in the wireless power receiver 200, and the wireless power receiver 200 may charge a battery 270 (see FIG. 4) with power received from the wireless power transmitter 100.

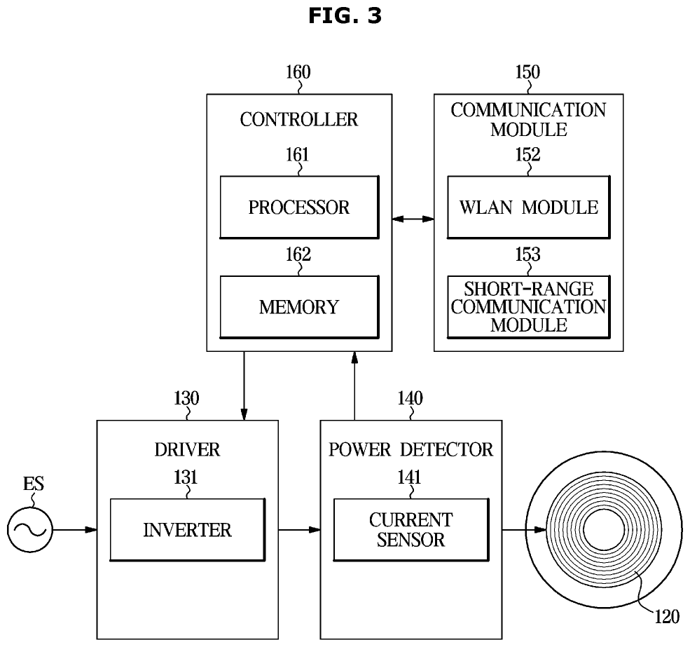

FIG. 3 is a control block diagram of a wireless power transmitter according to an embodiment.

Referring to FIG. 3, the wireless power transmitter 100 may include a driver 130, a power detector 140, a communication module 150, a controller 160 and the resonant coil 120.

The driver 130 may receive power from an external power source ES and apply a driving current to the resonant coil 120 according to a driving control signal that is received from the controller 160. Specifically, the driver 130 may apply an alternating current (AC) voltage to the resonant coil 120 and output an AC current (i.e., a driving current) according to the driving control signal of the controller 160.

For this, the driver 130 may include an inverter 131. The inverter 131 may apply an AC voltage and apply an AC current to the resonant coil 120. The inverter 131 may include at least one switch for allowing or blocking supply of the driving current to the resonant coil 120 and a resonant capacitor.

Although not shown, when the external power source ES supplies AC power, the driver 130 may include a rectifying circuit for converting AC power to direct current (DC) power and an amplifying circuit for amplifying the DC power output from the rectifying circuit. In this case, the rectifying circuit may switch the AC voltage output from the external power source ES to generate a DC voltage, and the amplifying circuit may amplify the DC voltage output from the rectifying circuit and provide the amplified DC voltage to the inverter 131.

The power detector 140 may include any component that is able to measure transmission power supplied to the resonant circuit.

For example, the power detector 140 may include a current sensor 141 that is able to measure the magnitude and direction of the driving current applied to the resonant coil 120. The current sensor 141 may measure a potential difference between both ends of a shunt resistor or measure a magnetic field according to the current.

The controller 160 may identify the magnitude of the driving current applied to the resonant coil 120 based on an output signal of the current sensor 141, and further calculate an amount of power wirelessly transmitted (amount of transmitted power) to the wireless power receiver by the resonant coil 120.

The communication module 150 may include a wireless local area network (WLAN) module 152 and a short-range communication module 153.

The WLAN module 152 may wirelessly exchange data with an access point (AP), and further exchange data with the wireless power receiver 200 (see FIG. 4) through the AP. For example, the WLAN module 152 may connect to a local network such as an intranet and/or a wide network such as the Internet through the AP. In addition, the wireless power receiver 200 may also connect to the local network and/or the wide network, and the WLAN module 152 may exchange data with the wireless power receiver 200 over the local network and/or the wide network.

The WLAN module 152 may wirelessly exchange data with the AP by using e.g., a wireless fidelity (Wi-Fi) communication protocol. The wireless power receiver 200 may also use the WLAN module to wirelessly exchange data with the AP.

The short-range communication module 153 may exchange data directly with the wireless power receiver 200. For example, the short-range communication module 153 may transmit a wireless signal directly to the wireless power receiver 200 and receive a wireless signal directly transmitted from the wireless power receiver 200.

The short-range communication module 153 may wirelessly exchange data with the wireless power receiver 200 by using e.g., a Wi-Fi direct communication protocol, a Bluetooth™ communication protocol or a near-field (NF) communication protocol.

The WLAN module 152 and/or the short-range communication module 153 may each include a dedicated antenna arranged separately from the resonant coil 120.

For example, the short-range communication module 153 may include an antenna formed in the shape of a concentric circle with the resonant coil 120 inside or outside of the resonant coil 120.

The controller 160 may include a processor 161 and a memory 162.

The controller 160 may be communicatively coupled with the communication module 150 to transmit or receive various data and/or information via signal.

For example, the processor 161 may be communicatively coupled with the short-range communication module 153, and transmit or receive various data and/or information with an external device (e.g., the wireless power receiver 200) through the short-range communication module 153.

The memory 162 may store a program, instructions, and data for controlling the operation of the wireless power transmitter 100. The processor 161 may generate control signals for controlling the operation of the wireless power transmitter 100 based on the program, instructions and data memorized and/or stored in the memory 162.

The memory 162 may store a program, instructions, and data for controlling the operation of the wireless power receiver 200. Accordingly, the processor 161 may generate a control signal to control the operation of the wireless power receiver 200.

The controller 160 may be implemented with a control circuit having the processor 161 and the memory 162 mounted thereon. The controller 160 may include a plurality of processors 161 and a plurality of memories 162.

The processor 161 may include logic circuits and operation circuits in hardware. The processor 161 may process the data according to the program and/or instructions provided from the memory 162 and generate a control signal based on the processing result. The memory 162 may include a volatile memory such as a static random access memory (SRAM), dynamic RAM (DRAM), etc., for temporarily storing data, and a non-volatile memory such as a read only memory (ROM), an erasable programmable ROM (EPROM), an electrically erasable programmable (ROM) (EEPROM), etc., for storing data for a long time.

The memory 162 may further store characteristic information of the wireless power receiver 200. The characteristic information of the wireless power receiver 200 may include a type of the wireless power receiver 200, a weight of the wireless power receiver 200, power control information and required power information relating to operation settings of the wireless power receiver 200. Various characteristic information of the wireless power receivers 200 may be stored in a list. The characteristic information of the wireless power receiver 200 may be transmitted from the wireless power receiver 200 or obtained from an external server (not shown).

Apart from this, the wireless power transmitter 100 may further include other components.

Both configurations of the wireless power transmitter 100 and the wireless power receiver will now be described together with reference to FIG. 4.

FIG. 4 illustrates configurations of a wireless power transmitter and a wireless power receiver, according to an embodiment.

Referring to FIG. 4, the wireless power receiver 200 may include a receive coil 210, a rectifier 220, a power manager 230, a switch 240, a communication module 150, a controller 160, a battery 270, and a display 280.

Depending on the type of the wireless power receiver 200, one of the components shown in FIG. 4 may be omitted or another component may be added. For example, the wireless power receiver 200 may not include the display 280.

The display 280 may visually provide information to the outside or exterior (e.g., a user) of the wireless power receiver 200. In an embodiment, the display 280 may include a touch sensor configured to detect a touch or a pressure sensor configured to measure intensity of force generated by the touch.

The receive coil 210 of the wireless power receiver 200 may receive power through magnetic coupling with the resonant coil 120 of the wireless power transmitter 100. For this, the receive coil 210 and the resonant coil 120 may have the same resonant frequency.

In an embodiment, as the wireless power transmitter 100 supplies power to the wireless power receiver by using a wireless charging technology in a magnetic resonance method, the wireless power receiver 200 may receive wireless power as long as the wireless power receiver 200 is located within a preset distance to the wireless power transmitter 100 even without being placed on the plate 102 of the wireless power transmitter 100.

The rectifier 220 may output a DC voltage by rectifying an AC voltage received through the receive coil 210.

The controller 260 may detect a DC voltage value output from the rectifier 220 to calculate an amount of received power received by the receive coil 210.

The power manager 230 may use the DC voltage output by the rectifier 220 to charge the battery 270. In an embodiment, the power manager 230 may select a charging method (e.g., normal charging or fast charging) based on at least some of a type of an external power source (e.g., wireless charging), magnitude of power that may be supplied from the external power source (e.g., about 20 W or more), or an attribute of the battery 270, and charge the battery 270 by using the selected charging method.

Furthermore, the power manager 230 may generate power having a different voltage or a different current level by controlling the voltage level or current level of the power output by the rectifier 220 under the control of the controller 160. In this case, the power manager 230 may calculate a required amount of power of the battery 270 based on state-of-charge information (e.g., lifespan, overvoltage, low voltage, overcurrent, overcharge, over-discharge, overheat, short-circuit or expansion) relating to charging of the battery 270, and control the charging of the battery 270 according to the required amount of power (e.g., reduce charging current or voltage or stop charging).

The switch 240 may be turned on or off under the control of the controller 160. When the switch 240 is open and turned off, magnetic coupling between the resonant coil 120 and the receive coil 210 may be removed. In other words, when there is no need to receive power through the wireless power transmitter 100, the controller 160 may eliminate magnetic coupling between the resonant coil 120 and the receive coil 210 by opening and thereby turning the switch 240 off. When the switch 240 is closed and turned on, magnetic coupling between the resonant coil 120 and the receive coil 210 is possible. In other words, when there is a need to receive power through the wireless power transmitter 100, the controller 160 may provide for magnetic coupling between the resonant coil 120 and the receive coil 210 by closing and thereby turning the switch 240 on.

In an embodiment, the battery 270 may include a battery protection circuit (or a protection circuit module (PCM)). The battery protection circuit may perform one or more of various functions (e.g., a pre-blocking function) to prevent performance degradation or damage of the battery 270. Additionally or alternatively, the battery protection circuit may be configured as part of a battery management system (BMS) that is able to perform various functions including cell balancing, capacity measurement of the battery 270, measurement of the number of charging and discharging times, temperature measurement, or voltage measurement.

In an embodiment, at least part of the usage state information or the charging state information of the battery 270 may be measured using a corresponding sensor (e.g., temperature sensor) of the sensor module and the power manager 230. In an embodiment, the corresponding sensor (e.g., temperature sensor) of the sensor module may be included as part of the battery protection circuit or as a separate device located near the battery.

The controller 260 may include a processor and a memory, and the memory may store a program, instructions, and data for controlling the operation of the wireless power receiver 200 and the processor may generate control signals for controlling the operation of the wireless power receiver 200 based on the program, instructions and data memorized and/or stored in the memory.

The program memorized and/or stored in the memory may include, for example, an application.

For example, the processor may execute software (e.g., an application) to control at least one other component (e.g., the display 280) of the wireless power receiver 200 connected to the processor and perform various data processing or computation. In an embodiment, as at least part of the data processing or computation, the processor may store a command or data received from another component (e.g., the communication module 250) in the memory, process the command or data stored in the memory, and store the resultant data in the memory.

In an embodiment, the controller 260 may control the power manager 230 to charge the battery 270 according to the required amount of power.

Furthermore, in an embodiment, the controller 260 may provide various user interfaces by controlling the display 280. Moreover, the processor included in the controller 260 may execute an application stored in the memory based on a command signal received from the communication module 250.

Similar to the communication module 150 of the wireless power transmitter 100, the communication module 250 may include a WLAN module and/or a short-range communication module.

The short-range communication module included in the communication module 250 may establish communication with the short-range communication module 153 of the wireless power transmitter 100 to transmit various information and/or data.

For example, the wireless power transmitter 100 may send a wake-up message to the wireless power receiver 200 in response to the establishment of communication with the wireless power receiver 200, and the wireless power receiver 200 may send the wireless power transmitter 100 information about a product type, manufacturer information, a model name, a battery type, a charging method, an impedance value of a load, characteristic information of the receive coil 210, a required amount of power, a unique identifier, etc., of the wireless power receiver 200 in response to the reception of the wake-up message.

In an embodiment, the wireless power receiver 200 may include a gyro sensor and/or an angular velocity sensor for obtaining inclination information of the wireless power receiver 200, and send the inclination information to the wireless power transmitter 100. The inclination information may include information about a z-axis inclination.

Furthermore, in an embodiment, the wireless power receiver 200 may send information about an amount of received power received by the receive coil 210 to the wireless power transmitter 100.

Components of the wireless power transmitter 100 and the wireless power receiver 200 have thus far been described. Operations of the wireless power transmitter 100 will now be described based on the respective components.

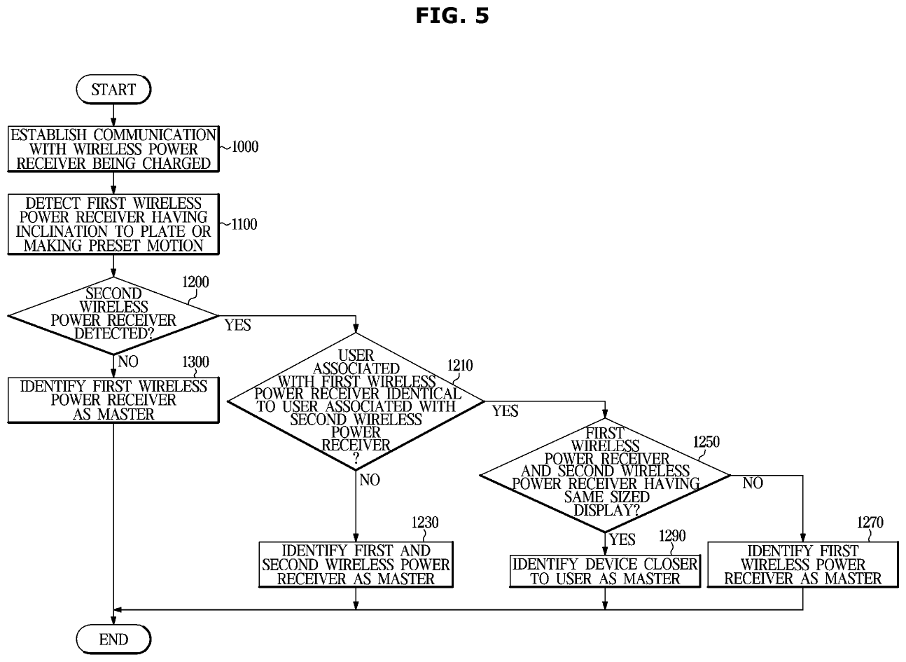

FIG. 5 is a flowchart illustrating an example in which a wireless power transmitter identifies a master wireless power receiver, according to an embodiment.

The master wireless power receiver may refer to the wireless power receiver 200 capable of providing a visual indication about states of charge of the plurality of wireless power receivers 200 receiving power through the wireless power transmitter 100.

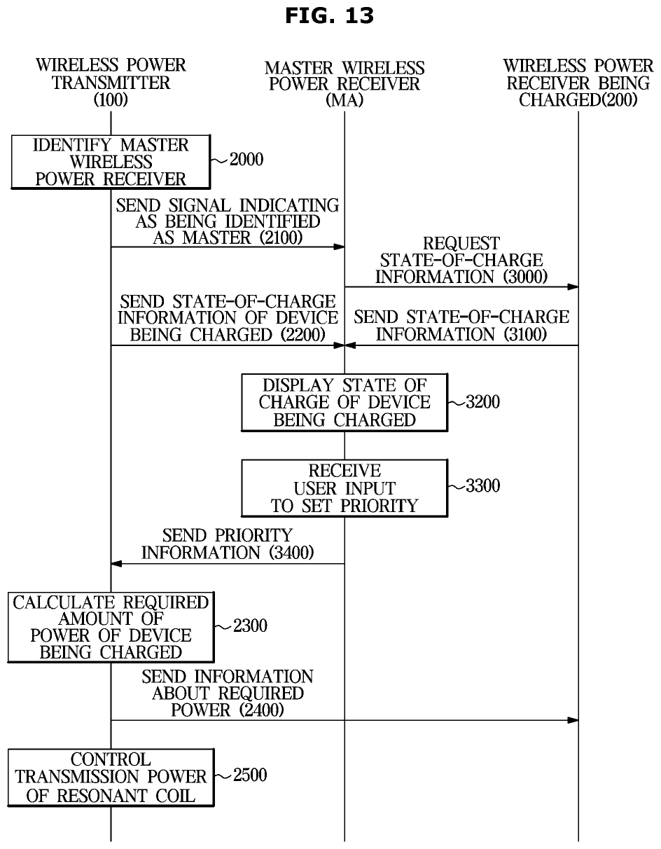

The master wireless power receiver will be described later in detail with reference to FIG. 13.

In the disclosure, only the wireless power receiver 200 having the display 280 is assumed to be identified as the master wireless power receiver.

Referring to FIG. 5, communication may be established between the wireless power transmitter 100 and the wireless power receiver 200 in 1000.

Specifically, when the wireless power receiver 200 comes to a chargeable range of the wireless power transmitter 100, communication may be established using the short-range communication module 153.

For example, when the wireless power receiver 200 comes to the chargeable range, the receive coil 210 may receive power provided from the wireless power transmitter 100, and the controller 260 may control the communication module 250 to establish communication with the wireless power transmitter 100 in response to the receive coil 210 receiving the power.

As described above, the wireless power transmitter 100 may receive various information from the wireless power receiver 200 through the short-range communication module 153.

When the plurality of wireless power receivers 200 come to the chargeable range of the wireless power transmitter 100, the wireless power transmitter 100 may receive various information from the plurality of wireless power receivers 200.

The controller 160 of the wireless power transmitter 100 may detect a first wireless power receiver having an inclination to the plate 102 or making a preset motion above the plate 102 based on the information received from the at least one wireless power receiver 200 through the short-range communication module 153 in 1100.

In other words, the controller 160 may detect the first wireless power receiver having an inclination to the plate 102 or making the preset motion above the plate 102 among the plurality of wireless power receivers 200.

That the wireless power receiver 200 has an inclination to the plate 102 may imply that the receive coil 210 of the wireless power receiver 200 is not placed in parallel with the resonant coil 120.

In an embodiment, the controller 160 may detect the first wireless power receiver having an inclination to the plate 102 based on a coupling coefficient value between the resonant coil 120 and the receive coil 210, and detect the first wireless power receiver having an inclination to the plate 102 based on inclination information obtained from the wireless power receivers.

For example, the controller 160 may obtain information about an amount of received power from the wireless power receiver 200, and determine a coupling coefficient value between the wireless power transmitter 100 and the wireless power receiver based on the amount of received power of the wireless power receiver 200 and an amount of transmitted power of the wireless power transmitter 100.

More specifically, the controller 160 may determine the coupling coefficient value between the resonant coil 120 and the receive coil 210 based on the following equation 1:

k=M/\sqrt{L₁L₂} [Equation 1]

where k denotes a coupling coefficient, L₁ denotes magnetic inductance of the resonant coil 120, L₂ denotes magnetic inductance of the receive coil 210, and M denotes mutual inductance of the resonant coil 120 and the receive coil 210.

As the value of L₁ is stored in the memory 162 of the wireless power transmitter 100 and the value of L₂ may be received from the wireless power receiver 200, the wireless power transmitter 100 needs to calculate the mutual inductance M of the resonant coil 120 and the receive coil 210.

The value of the mutual inductance M may be easily derived in the existing method based on the amount of transmitted power of the resonant coil 120 and the amount of received power of the receive coil 210.

As the leakage flux increases, the smaller the coupling coefficient value, and the controller 160 may estimate an angle and/or a distance between the wireless power receiver 200 and the wireless power transmitter 100 based on the coupling coefficient value.

For example, the angle and/or distance of the wireless power transmitter 100 matched with the coupling coefficient value may be stored in the memory 162 in the form of a lookup table.

Accordingly, the controller 160 may detect the first wireless power receiver among the wireless power receivers 200 with which communication is established, in response to the coupling coefficient value between the first wireless power receiver and the resonant coil 120 falling within a preset range.

In other words, when the coupling coefficient value between the wireless power transmitter 100 and the wireless power receiver 200 is in the preset range, the controller 160 may estimate that the resonant coil 120 and the receive coil 210 are not aligned and determine that the wireless power receiver 200 is inclined to the plate 102.

In another example, the controller 160 may obtain the inclination information from the wireless power receiver 200 through the short-range communication module 153 and detect the first wireless power receiver based on the inclination information.

As the plate 102 is arranged to be parallel with the ground, the controller 160 may detect the first wireless power receiver in response to the inclination information received from the first wireless power receiver having a z-axis inclination.

This is because the user may easily check the display of the master wireless power receiver when the master wireless power receiver is inclined to the plate 102.

When the first wireless power receiver having an inclination to the plate 102 is detected but the second wireless power receiver having an inclination to the plate 102 or making a preset motion above the plate 102 is not detected among the plurality of wireless power receivers 200 in 1200, the controller 160 may identify the first wireless power receiver as the master wireless power receiver in 1300.

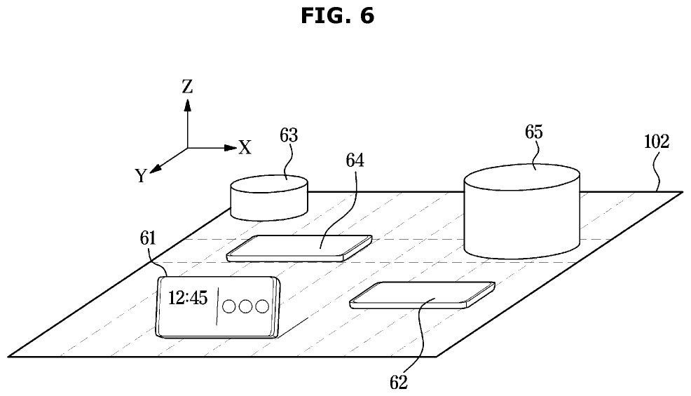

FIG. 6 is a perspective view illustrating an occasion when there is a wireless power receiver having an inclination to a plate of the wireless power transmitter according to an embodiment.

Referring to FIG. 6, among a plurality of wireless power receivers 61, 62, 63, 64 and 65 which are receiving wireless power from the wireless power transmitter 100 (see FIGS. 2 and 4), a first wireless power receiver 61 having an inclination to the plate 102 may be identified.

In this case, the controller 160 may identify the detected first wireless power receiver 61 as the master wireless power receiver.

According to the embodiment, the user may designate the wireless power receiver 61 as the master wireless power receiver by using an accessory or holder to place the wireless power receiver 61 upright on the plate 102. Furthermore, when the wireless power receiver 61 is a device, e.g., a foldable device, at least a portion of which may be rotated on a hinge, the user may designate the wireless power receiver 61 as the master wireless power receiver by rotating the at least a portion of the wireless power receiver 61 to be placed on the plate 102.

That the wireless power receiver 200 making a preset motion may imply that the user may make a particular gesture while gripping the wireless power receiver 200.

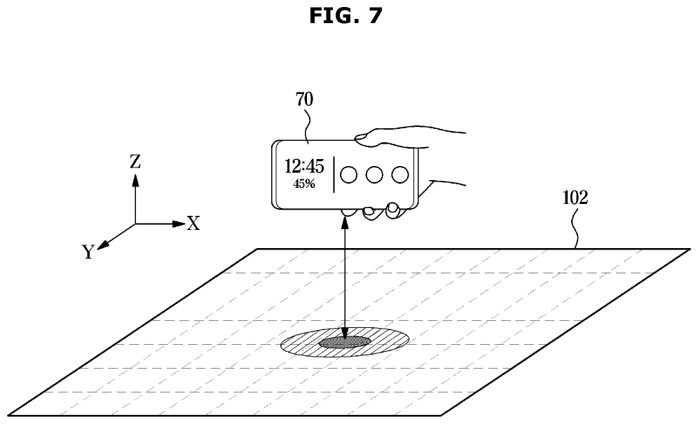

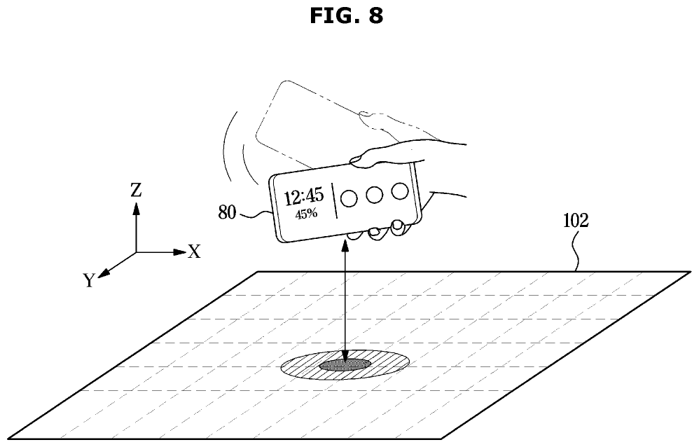

FIGS. 7 and 8 are perspective views illustrating an example in which the user makes a preset motion with a wireless power receiver on a plate of a wireless power transmitter, according to an embodiment.

Referring to FIGS. 7 and 8, as an example of the preset motion, there may be a hovering motion to keep a wireless power receiver 70 motionless at a certain height over the plate 102 and/or a shake motion to shake a wireless power receiver 80 above the plate 102.

The controller 160 may detect the first wireless power receiver 70 that is making the hovering motion, in response to the coupling coefficient value between the first wireless power receiver 70 and the resonant coil 120 being maintained at a preset value or less for a preset period of time.

This is because a fact that the user is intentionally making the hovering motion while gripping the wireless power receiver may be estimated when the coupling coefficient value between the resonant coil 120 and the receive coil 210 is maintained at the preset value or less for the preset period of time.

Furthermore, the controller 160 may detect the first wireless power receiver 80 that is making the shake motion, in response to the coupling coefficient value between the first wireless power receiver 80 and the resonant coil 120 changing in a preset pattern.

This is because a fact that the user is intentionally making the shake motion while gripping the wireless power receiver may be estimated when the coupling coefficient value between the resonant coil 120 and the receive coil 210 changes in the preset pattern.

In an embodiment, the controller 160 may obtain the inclination information from the first wireless power receiver 80, and detect the first wireless power receiver 80 that is making the shaking motion in response to the inclination of the first wireless power receiver 80 changing in the preset pattern.

When the first wireless power receiver 70 or 80 making a preset motion above the plate 102 is detected but the second wireless power receiver having an inclination to the plate 102 or making the preset motion above the plate 102 is not detected among the plurality of wireless power receivers 200 in 1200 of FIG. 5, the controller 160 may identify the first wireless power receiver 70 or 80 as the master wireless power receiver in 1300 of FIG. 5.

According to the embodiment, the user may designate the wireless power receiver 70 or 80 as the master wireless power receiver by making a simple motion and/or gesture while gripping the wireless power receiver 70 or 80.

Furthermore, even when the first wireless power receiver having an inclination to the plate 102 or making a preset motion above the plate 102 is not detected in 1100 of FIG. 5, the controller 160 may detect the second wireless power receiver that has received a user input that designates it as the master wireless power receiver through the interface.

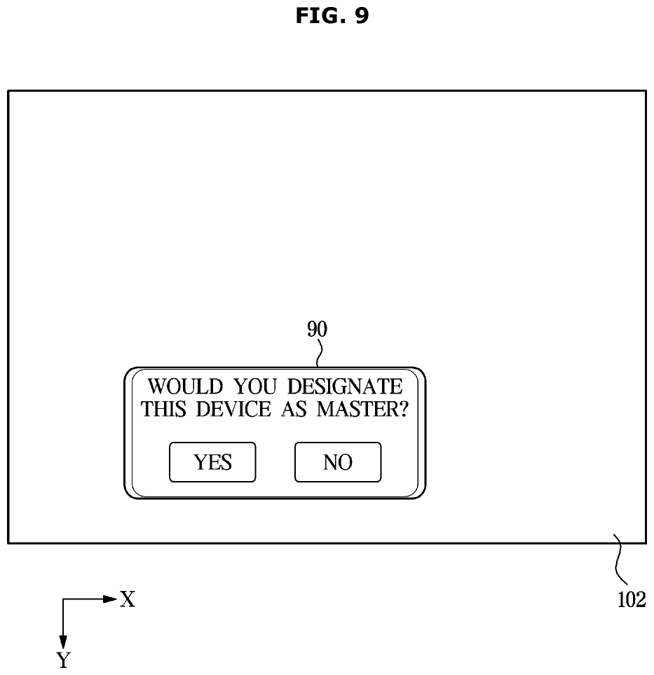

FIG. 9 illustrates an example in which the wireless power transmitter 100 transmits a command signal to provide an interface for designating a master wireless power receiver, according to an embodiment.

Referring to FIG. 9, in response to an establishment of a communication connection with the second wireless power receiver 90 through the short-range communication module 153, the controller 160 may transmit, to the second wireless power receiver 90, a command signal to provide an interface for designating the second wireless power receiver 90 as the master wireless power receiver.

In other words, when the user moves the second wireless power receiver 90 into a chargeable area, the display of the second wireless power receiver 90 may output a message asking for an intention of the user.

For example, the display of the second wireless power receiver 90 may display a sentence “would you designate this device as a master device?”, and the user may then touch a word “yes” to enter a command to designate the second wireless power receiver 90 as the master wireless power receiver.

The second wireless power receiver 90 may transmit a first signal to the wireless power transmitter 100, in response to receiving the user input to designate the second wireless power receiver 90 as the master wireless power receiver.

The controller 160 may identify the second wireless power receiver 90 as the master wireless power receiver, in response to receiving the first signal from the second wireless power receiver 90 in 1300 of FIG. 5.

According to the embodiment, the user may designate a wireless power receiver as the master wireless power receiver by using an interface automatically output on the wireless power receiver.

In an embodiment, the wireless power transmitter 100 may identify the master wireless power receiver without regard to the order as shown in FIG. 5.

Furthermore, in an embodiment, the wireless power transmitter 100 may keep identifying the particular wireless power receiver as the master wireless power receiver even when the particular wireless power receiver fails to continue to meet a condition to be identified as the master wireless power receiver after being identified as the master wireless power receiver.

For example, after the first wireless power receiver inclined to the plate 102 is identified as the master wireless power receiver, even when the first wireless power receiver is determined as not being inclined to the plate 102, the controller 160 may identify the first wireless power receiver as the master wireless power receiver.

Furthermore, in an embodiment, the wireless power transmitter 100 may identify the master wireless power receiver by prioritizing detection conditions.

For example, when the first wireless power receiver inclined to the plate 102 and the second wireless power receiver making a preset motion above the plate 102 are detected among the wireless power receivers 200, the wireless power transmitter 100 may identify only one of the first wireless power receiver or the second wireless power receiver as the master wireless power receiver.

In another example, when the first wireless power receiver inclined to the plate 102 and the second wireless power receiver having received the user input to designate it as the master wireless power receiver are detected among the wireless power receivers 200, the wireless power transmitter 100 may identify the second wireless power receiver as the master wireless power receiver.

Furthermore, in an embodiment, when another wireless power receiver is identified as the master wireless power receiver after a particular wireless power receiver is identified as the master wireless power receiver, the wireless power transmitter 100 may no longer identify the particular wireless power receiver as the master wireless power receiver.

For example, when another wireless power receiver (e.g., the second wireless power receiver) is identified as the master wireless power receiver after the first wireless power receiver is identified as the master wireless power receiver, the controller 160 may send the first wireless power receiver a signal indicating that the first wireless power receiver is released from the position as the master wireless power receiver, through the short-range communication module 153.

That is, the first wireless power receiver having served as the master wireless power receiver may finish the role when another master wireless power receiver is identified.

Specifically, the first wireless power receiver having executed an application to indicate states of charge of the plurality of wireless power receivers 200 to play the role of the master wireless power receiver may stop running the application in response to receiving a signal indicating that the position as the master wireless power receiver is released.

Turning back to FIG. 5, in an embodiment, the wireless power transmitter 100 may identify one or both of the first wireless power receiver or the second wireless power receiver as the master wireless power receiver, when both the first and second wireless power receivers having an inclination to the plate 102 or making a preset motion above the plate 102 are detected among the plurality of wireless power receivers 200 in 1200 of FIG. 5.

For example, when the first wireless power receiver having an inclination to the plate 102 or making a preset motion is detected in 1100 of FIG. 5 and the second wireless power receiver having an inclination to the plate 102 or making a preset motion is detected in 1200 of FIG. 5, the controller 160 may determine whether the user associated with the first wireless power receiver and the user associated with the second wireless power receiver are the same in 1210 of FIG. 5.

When it is determined that the user associated with the first wireless power receiver and the user associated with the second wireless power receiver are identical in 1210 of FIG. 5, the controller 160 may identify only one of the first wireless power receiver or the second wireless power receiver as the master wireless power receiver.

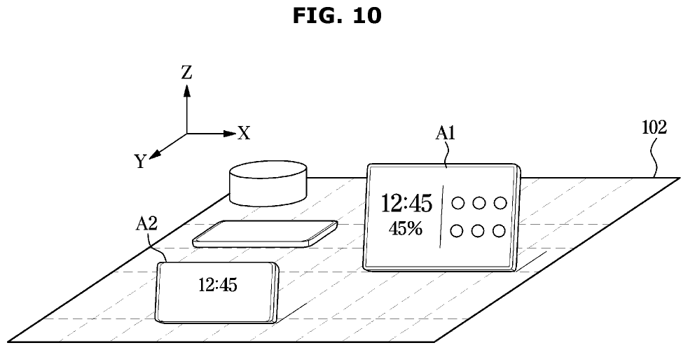

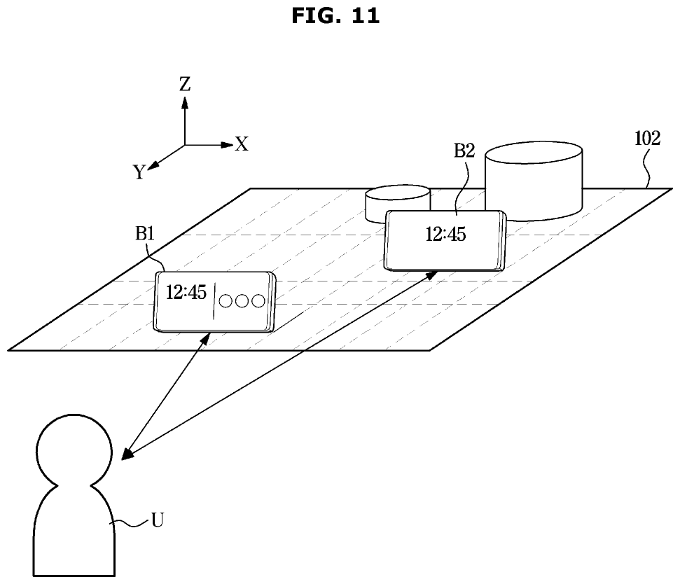

FIGS. 10 and 11 are perspective views illustrating an occasion when there are multiple wireless power receivers having inclinations to a plate of a wireless power transmitter, according to an embodiment.

When the first wireless power receiver having an inclination to the plate 102 or making a preset motion is detected and the second wireless power receiver having an inclination to the plate 102 or making a preset motion is detected in 1200 of FIG. 5, the controller 160 may compare the sizes of the displays of the first wireless power receiver and the second wireless power receiver in 1250 of FIG. 5.

Referring to FIG. 10, when the sizes of the displays of a first wireless power receiver A1 and a second wireless power receiver A2 are different from each other in 1250 of FIG. 5, the controller 160 may identify only the first wireless power receiver A1 having the display of a bigger size as the master wireless power receiver among the first wireless power receiver A1 and the second wireless power receiver A2 in 1270 of FIG. 5.

This is because the bigger the size of the display, the more easily the user may check the screen displayed on the master wireless power receiver.

Referring to FIG. 11, when the sizes of the displays of a first wireless power receiver B1 and a second wireless power receiver B2 are the same in 1250 of FIG. 5, the controller 160 may identify only the first wireless power receiver B1 located closer to the user U as the master wireless power receiver among the first wireless power receiver B1 and the second wireless power receiver B2 in 1290 of FIG. 5.

This is because the closer the wireless power receiver is to the user, the more easily the user may check the screen displayed on the master wireless power receiver.

For this, the controller 160 may receive location information of the user U from the first wireless power receiver B1 and the second wireless power receiver B2 through the short-range communication module 153.

The first wireless power receiver B1 and the second wireless power receiver B2 may each use an ultrawideband (UWB) sensor equipped therein to detect a UWB signal output by a UWB module of a wearable device worn by the user U, and obtain the location information of the user U based on the UWB signal. Alternatively, the first wireless power receiver B1 and the second wireless power receiver B2 may each obtain the location information of the user U based on image data obtained from a camera equipped therein.

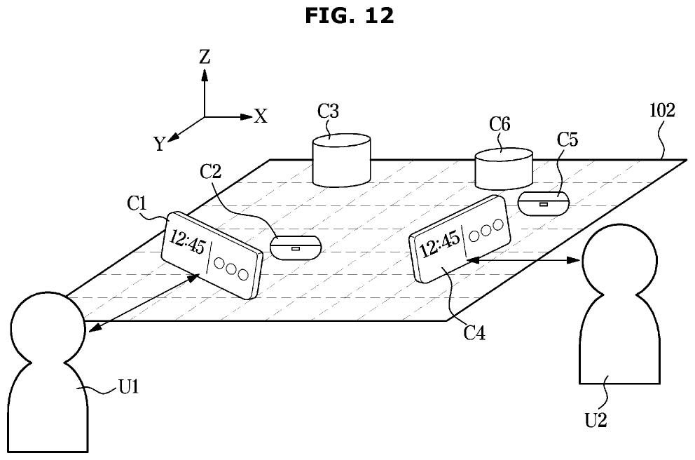

Referring to FIG. 12, when one (e.g., C1) of a first wireless power receiver C1 and a second wireless power receiver C4 is a device associated with a first user U1 and the other is a device associated with a second user U2, the controller 160 may identify both the first and second wireless power receivers C1 and C4 as the master wireless power receiver.

In other words, when the user U1 associated with the first wireless power receiver C1 and the user U2 associated with the second wireless power receiver C4 are different in 1210 of FIG. 5, both the first and second wireless power receivers C1 and C4 may be identified as the master wireless power receiver in 1230 of FIG. 5.

The device associated with the first user may refer to a device connected to a certain server (e.g., a smart things server) by an account of the first user or a device connected with the account of the first user, and the device associated with the second user may refer to a device connected to the certain server by an account of the second user or a device connected with the account of the second user.

In this case, the master wireless power receiver may be classified as the first master wireless power receiver C1 associated with the first user U1 and the second master wireless power receiver C4 associated with the second user U2.

The first master wireless power receiver C1 may serve as a master for wireless power receivers C2 and C3 associated with the first user U1, and the second master wireless power receiver C4 may serve as a master for wireless power receivers C5 and C6 associated with the second user U2.

Specifically, the controller 160 may transmit information about states of charge of the wireless power receivers C2 and C3 associated with the first user U1 to the first master wireless power receiver C1 and transmit information about states of charge of the wireless power receivers C5 and C6 associated with the second user U2 to the second master wireless power receiver C4 through the short-range communication module 153.

In this case, the first master wireless power receiver C1 may indicate states of charge of the wireless power receivers C2 and C3 associated with the first user U1, and the second master wireless power receiver C4 may indicate states of charge of the wireless power receivers C5 and C6 associated with the second user U2.

A procedure in which the wireless power transmitter 100 identifies the master wireless power receiver has thus far been described according to the embodiments.

A role of the master wireless power receiver will now be described in detail.

In the embodiments of FIGS. 10, 11 and 12, or in other cases in which multiple master wireless power receivers are identified, the master wireless power receivers can be identified with a priority sequence. In these or other cases, at an initial time, one particular master wireless power receiver may be identified as the master wireless power receiver with the highest priority and another master wireless power receiver may be identified with the second-highest priority. This can be achieved by sending each master wireless power receiver an additional signal that is indicative of the priorities. Here, once it is determined that the particular master wireless power receiver initially identified as the master wireless power receiver with the highest priority can no longer function in that capacity (i.e., because it has been shut down or moved out of the vicinity), the other master wireless power receiver identified as having the second-highest priority becomes the master wireless power receiver with the highest priority by default.

FIG. 13 is a sequence chart illustrating an example of operations of a wireless power transmitter and a master wireless power receiver according to an embodiment.

Referring to FIG. 13, as described above, the controller 160 may identify a master wireless power receiver among the plurality of wireless power receivers 200 in 2000.

For example, the controller 160 may identify a first wireless power receiver among the plurality of wireless power receivers 200 as a master wireless power receiver MA, and send the master wireless power receiver (e.g., the first wireless power receiver) a signal indicating that it is identified as the master wireless power receiver (hereinafter, a master signal) in 2100.

The wireless power receiver having received the master signal may take preset action corresponding to the master signal.

Along with this, the controller 160 may send information about a type and a state of charge of each of the wireless power receivers 200 to the master wireless power receiver MA in 2200. In other words, the wireless power transmitter 100 may receive the state-of-charge information from the wireless power receivers 200 and forward the state-of-charge information received from the wireless power receivers 200 to the master wireless power receiver MA.

Alternatively, the controller 160 may simply send only the master signal to the master wireless power receiver MA, and the master wireless power receiver MA may request state-of-charge information from the wireless power receivers 200 being charged in response to receiving the master signal in 3000.

The wireless power receivers 200 being charged may send the respective state-of-charge information in response to the request from the master wireless power receiver MA in 3100.

In other words, in an embodiment, the wireless power transmitter 100 may send the state-of-charge information of the wireless power receivers 200 being charged directly to the master wireless power receiver MA in 2200 or the master wireless power receiver MA may obtain the state-of-charge information directly from the wireless power receivers 200 being charged in 3100.

After obtaining the state-of-charge information of the wireless power receivers 200 being charged, the master wireless power receiver MA may indicate or display the states of charge of the plurality of wireless power receivers 200 in 3200.

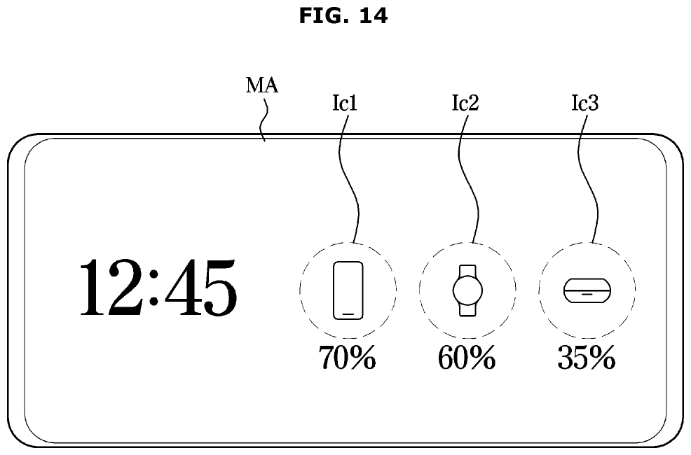

FIG. 14 illustrates an example in which a master wireless power receiver identified by a wireless power transmitter provides a visual indication of states of charge of wireless power receivers being charged, according to an embodiment.

Referring to FIG. 14, the master wireless power receiver MA may use the display to provide visual indications of the respective states of charge of the wireless power receivers 200.

Specifically, if it is assumed that the wireless power receivers 200 currently receiving power from the wireless power transmitter 100 are a smart phone, a smart watch, and wireless earpieces, the smart phone can be identified as the master wireless power receiver MA.

In this case, the wireless power transmitter 100 may send the master wireless power receiver MA information indicating that an amount of charge of the smart watch is 60% and that an amount of charge of the wireless earpieces is 35%. In another embodiment, the master wireless power receiver MA may directly request states-of-charge information from the smart watch and the wireless earpieces and obtain information indicating that an amount of charge of the smart watch is 60% and an amount of charge of the wireless earpieces is 35%.

The master wireless power receiver MA may execute an application for indicating states of charge of the plurality of wireless power receivers 200 according to the master signal sent from the wireless power transmitter 100 to display its amount of charge (e.g., 70%) along with a smart phone icon Ic1, an amount of charge (e.g., 60%) of the smart watch along with a smart watch icon Ic2, and an amount of charge (e.g., 35%) of the wireless earpieces along with a wireless earpieces icon Ic3.

How to provide visual indications about states of charge of the respective wireless power receivers 200 may be different depending on the version or type of the application.

For example, the order in which the icons of the wireless power receivers 200 are arranged may be changed depending on the application, in the order from the highest charging percentage, the highest charging rate, or the largest amount of power required.

In another example, product names may be displayed instead of the icons depending on the application. Battery guages may be displayed instead of the percentage to display a remaining amount of the battery depending on the application.

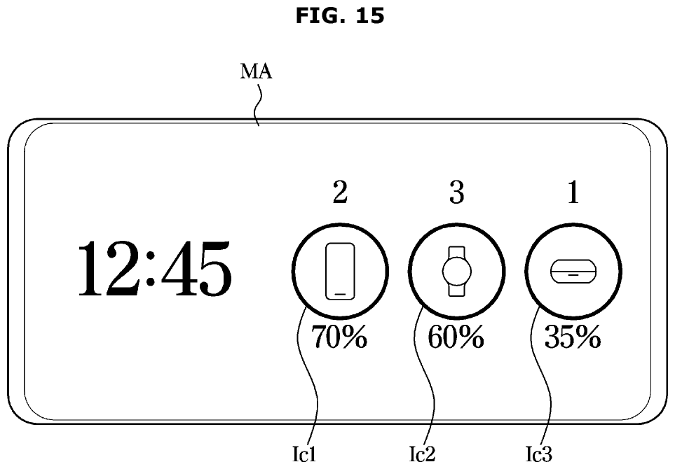

FIG. 15 illustrates an example in which a master wireless power receiver identified by a wireless power transmitter provides an interface for setting priorities, according to an embodiment.

Referring to FIG. 15, the master wireless power receiver MA may use the display to provide an interface for prioritizing the wireless power receivers 200.

The user may use the interface of the master wireless power receiver MA to input a user command to set priorities of the plurality of wireless power receivers 200, and the master wireless power receiver MA may receive the user input to set the priorities in 3300 of FIG. 13.

Specifically, the user may set the priorities by sequentially touching the icons Ic1, Ic2 and Ic3 displayed on the master wireless power receiver MA according to the priorities.

For example, the user may set the wireless earpieces to have the first charging priority and the smart phone to have the second charging priority by touching the wireless earpieces icon Ic3 first and then the smart phone icon Ic1 next.

Furthermore, the user may release the priority by retouching the icon already allocated a priority.

In another example, the user may touch and drag the respective icons Ic1, Ic2 and Ic3 displayed on the master wireless power receiver MA, and set priorities by sequentially arranging the icons Ic1, Ic2 and Ic3 according to the priorities.

For example, the user may set the wireless earpieces to have the first charging priority and the smart phone to have the second charging priority by touching and dragging the wireless earpieces icon Ic3 to the leftmost and the smart phone icon Ic1 to the right side of the wireless earpieces icon Ic3.

The interface provided for the user to allocate charging priorities of the wireless power receivers 200 may be different depending on the version or type of the application.

As such, the master wireless power receiver MA may obtain priority information of the wireless power receivers 200, and send the priority information to the wireless power transmitter 100 in 3400 of FIG. 13.

For example, the master wireless power receiver MA may send the wireless power transmitter 100 information indicating that the wireless earpieces has the first charging priority, the smart phone has the second charging priority and the smart watch has the third charging priority.

When obtaining the priority information of the wireless power receivers 200 being charged, the controller 160 may calculate required power of the respective wireless power receivers 200 based on the priority information, in 2300.

Furthermore, the controller 160 may control transmission power based on the priority information in 2500.

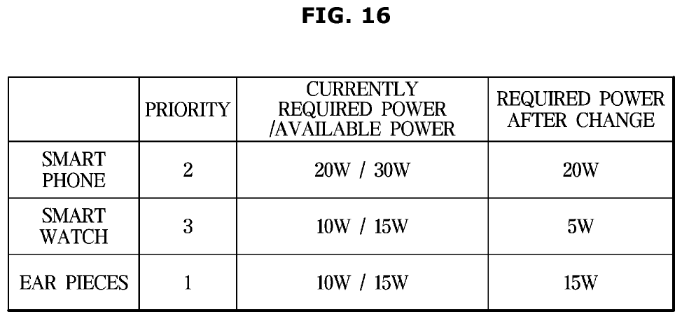

FIG. 16 illustrates an example in which a master wireless power receiver identified by a wireless power transmitter calculates required power according to priorities, according to an embodiment.

Referring to FIG. 16, the controller 160 may suitably distribute the transmission power to the respective wireless power receives 200 (e.g., a smart phone, a smart watch, and wireless earpieces) based on currently required power and available power of the wireless power receivers 200 in 2400.

For example, when the maximum transmission power of the resonant coil 120 is limited to 40 W, the controller 160 may send the wireless earpieces a command signal to change a required amount of power of the wireless earpieces from 10 W to 15 W, and send the smart watch a command signal to change a required amount of power of the smart watch from 10 W to 5 W.

In an embodiment, the controller 160 may send the master wireless power receiver MA a command signal to change the required amount of power of the wireless earpieces from 10 W to 15 W and a command signal to change the required amount of power of the smart watch from 10 W to 5 W, and the master wireless power receiver MA may send the wireless earpieces a command signal to change a required amount of power of the wireless earpieces from 10 W to 15 W and send the smart watch a command signal to change a required amount of power of the smart watch from 10 W to 5 W.

The wireless earpieces may change its required amount of power to 15 W in response to receiving the command signal to change the required amount of power to 15 W.

The smart watch may change its required amount of power to 5 W in response to receiving the command signal to change the required amount of power to 5 W.

Specifically, the wireless power receiver 200 may adjust the required amount of power by controlling the power manager 230.

In another example, when the maximum transmission power of the resonant coil 120 is limited to 50 W, the controller 160 may adjust the transmission power of 40 W to 50 W by controlling the driver 130.

In other words, the resonant coil 120 that has output 40 W of transmission power may output 50 W of transmission power under the control of the controller 160.

Afterward, the controller 160 may send the wireless earpieces a command signal to change the required amount of power of the wireless earpieces from 10 W to 15 W, and send the smart watch a command signal to change the required amount of power of the smart phone from 20 W to 30 W.

An algorithm to calculate required amounts of power of the wireless power receivers 200 according to the priorities may be stored in the memory 162.

Although not shown, when there is a controllable wireless power receiver (e.g., a small home appliance such as an electric kettle, a blender, a toaster, an electric oven, a coffee machine, etc.) among the wireless power receivers 200, the master wireless power receiver MA may use the display to provide an interface for controlling the wireless power receiver.

For example, when the master wireless power receiver MA executes an application to provide an interface for controlling the wireless power receiver, the interface as shown in FIG. 14 may be provided.

The user may activate operation of a controllable wireless power receiver (e.g., an electric kettle) by touching an icon of the electric kettle twice in succession.

Furthermore, the user may activate the operation of the controllable wireless power receiver by touching a virtual power button displayed around the icon of the wireless power receiver.

Specifically, the master wireless power receiver MA may send a second signal to operate a controllable wireless power receiver to the wireless power transmitter 100 in response to touching the icon of the controllable wireless power receiver twice, and the wireless power transmitter 100 may transmit a command signal to operate the controllable wireless power receiver to the corresponding wireless power receiver in response to receiving the second signal.

In an embodiment, the master wireless power receiver MA may send the second signal to operate the controllable wireless power receiver directly to the corresponding wireless power receiver, in response to touching an icon of the controllable wireless power receiver twice.

Furthermore, when there is a controllable wireless power receiver among the wireless power receivers 200 being charged, the wireless power transmitter 100 may send operation state information of the controllable wireless power receiver to the master wireless power receiver MA. The operation state information may include information about an ON or OFF state of the wireless power receiver.

In an embodiment, the master wireless power receiver MA may request and obtain the operation state information directly from the controllable wireless power receiver.

The master wireless power receiver MA may use the display to display the operation state information of the controllable wireless power receiver.

Although not shown, when there is no wireless power receiver receiving power through the resonant coil 120 except for the master wireless power receiver MA, the controller 160 may send the master wireless power receiver MA information indicating that there is no other wireless power receiver being charged. This is because the master wireless power receiver for displaying states of charge of a plurality of wireless power receivers is of no use when there is no other wireless power receiver being charged through the resonant coil 120.

On receiving the information indicating that there is no other wireless power receiver being charged, the master wireless power receiver MA may execute an application unrelated with the state of charge.

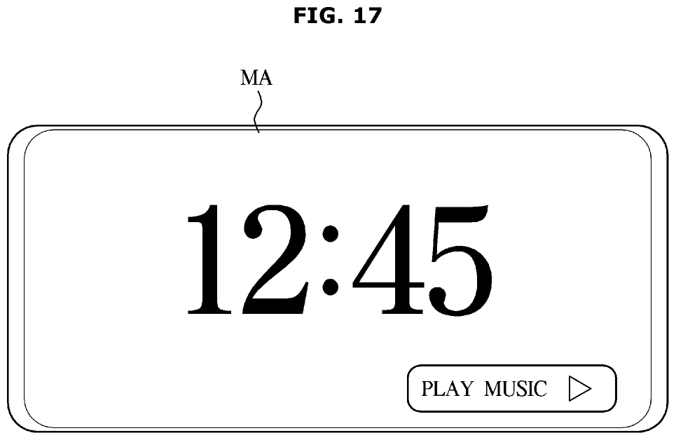

FIG. 17 illustrates an example of an application executed by a master wireless power receiver while there is no wireless power receiver that receives power through a wireless power transmitter except for the master wireless power receiver, according to an embodiment.

Referring to FIG. 17, an application unrelated with the state of charge may include an application for providing a visual indication of the current time (e.g., a clock application).

The clock application may provide a visual indication of the current time when the clock application is executed by the master wireless power receiver MA, and the user may use the master wireless power receiver MA as a clock.

In another example, the application unrelated with the state of charge may include an application for playing music (e.g., a music streaming application).

The music streaming application may play music when executed by the master wireless power receiver MA, and the user may use the master wireless power receiver MA as a speaker.

The user may listen to music just by placing the wireless power receiver 200 upright on the plate 102.

Furthermore, the user may set a function and/or application that is automatically executed when the wireless power receiver 200 is operated as the master wireless power receiver MA through the user interface of the wireless power receiver 200.

According to the setting by the user, the wireless power receiver 200 identified as the master wireless power receiver MA may provide a function or an application designated by the user.

According to embodiments of the disclosure, a wireless power transmitter may be a tool for managing states of charge of wireless power receivers being charged, allowing the user to manage the states of charge of the wireless power receivers more easily.

Furthermore, even when the wireless power transmitter is not equipped with a display, the user may use a master wireless power receiver to manage the states of charge of the wireless power receivers more easily.

Moreover, a wireless power receiver inclined to the plate of the wireless power transmitter may be used as the master wireless power receiver, so that the user may figure out states of charge of a plurality of wireless power receivers more easily.

In addition, the master wireless power receiver is designated according to the intention of the user, thereby increasing convenience for the user.

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

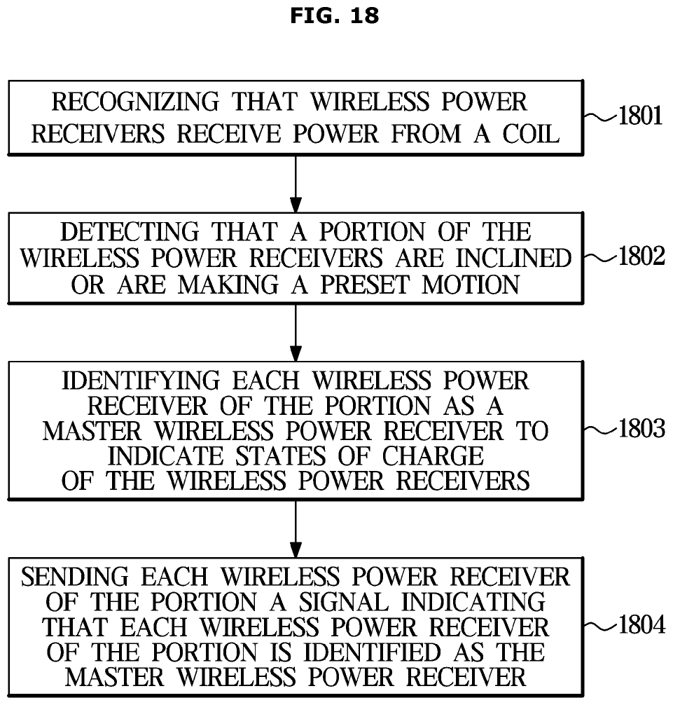

FIG. 18 is a flow diagram illustrating a method of controlling a wireless power transmitter according to an embodiment.

Referring to FIG. 18, the method includes recognizing that wireless power receivers receive power from a coil 1801, detecting that a portion of the wireless power receivers are inclined or are making a preset motion 1802, identifying each wireless power receiver of the portion as a master wireless power receiver to indicate states of charge of the wireless power receivers 1803 and sending each wireless power receiver of the portion a signal indicating that each wireless power receiver of the portion is identified as the master wireless power receiver 1804.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The computer-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a recording medium (e.g., a compact disc read only memory (CD-ROM)), through an application store (e.g., Play Store™) directly between two user devices (e.g., smart phones), or online (e.g., downloaded or uploaded). In the case of online distribution, at least part of the computer program product (e.g., a downloadable app) may be at least temporarily stored or arbitrarily created in a recording medium that may be readable to a device such as a server of the manufacturer, a server of the application store, or a relay server.

It is understood that various embodiments of the disclosure and associated terms are not intended to limit technical features herein to particular embodiments, but encompass various changes, equivalents, or substitutions. Like reference numerals may be used for like or related elements throughout the drawings. The singular form of a noun corresponding to an item may include one or more items unless the context states otherwise. Throughout the specification, “A or B”, “at least one of A and B”, “at least one of A or B”, “A, B or C”, “at least one of A, B and C”, and “A, B, or C” may each include any one or all the possible combinations of A, B and C. Terms like “first”, “second”, etc., may be simply used to distinguish an element from another, without limiting the elements in a certain sense (e.g., in terms of importance or order). When an element is mentioned as being “coupled” or “connected” to another element with or without an adverb “functionally” or “operatively”, it means that the element may be connected to the other element directly (e.g., wiredly), wirelessly, or through a third element.

In various embodiments of the disclosure, the term “module”, “device”, “member”, or “block” may refer to a unit implemented in hardware, software, or firmware, and may be interchangeably used with e.g., logic, logic block, part, or circuit. The module may be an integral part that performs one or more functions, or a minimum unit or a portion of the part. For example, in an embodiment, the module may be configured with an application-specific integrated circuit (ASIC).

In various embodiments, each of the aforementioned components (e.g., a module or a program) may include a single entity or multiple entities, and some of the multiple entities may be separately arranged in another component. In various embodiments, one or more of the aforementioned components or operations may be omitted, or one or more of other components or operations may be added. Alternatively or additionally, a plurality of components (e.g., modules or programs) may be integrated into a single component. In this case, the integrated component may perform one or more functions of the respective components therein equally or similarly to what are performed by the plurality of components before integration. According to various embodiments, operations performed by the module, the program, or another component may be carried out sequentially, in parallel, repeatedly, or heuristically, or one or more of the operations may be executed in a different order or omitted, or one or more other operations may be added.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

1. A wireless power transmitter comprising:
a plate;
a resonant coil;
a short-range communication module configured to communicate with a plurality of wireless power receivers which receive power from the resonant coil; and
a processor communicatively coupled with the short-range communication module,
wherein the processor is configured to:
detect a first wireless power receiver being inclined to the plate or making a preset motion above the plate among the plurality of wireless power receivers,
identify the first wireless power receiver as a master wireless power receiver to indicate states of charge of the plurality of wireless power receivers, and
send the first wireless power receiver a signal indicating that the first wireless power receiver is identified as the master wireless power receiver.

2. The wireless power transmitter of claim 1, wherein the processor is configured to:
receive information about amounts of received power of the plurality of wireless power receivers, and
determine a coupling coefficient value between each of the plurality of wireless power receivers and the resonant coil based on the amounts of received power of the plurality of wireless power receivers and an amount of transmitted power of the resonant coil.

3. The wireless power transmitter of claim 2, wherein the processor is configured to detect the first wireless power receiver in response to a coupling coefficient value between the first wireless power receiver and the resonant coil being within a preset range.

4. The wireless power transmitter of claim 2, wherein the processor is configured to detect the first wireless power receiver in response to a coupling coefficient value between the first wireless power receiver and the resonant coil being maintained at a preset value or less for a preset period of time.

5. The wireless power transmitter of claim 2, wherein the processor is configured to detect the first wireless power receiver in response to a coupling coefficient value between the first wireless power receiver and the resonant coil changing being in a preset pattern.

6. The wireless power transmitter of claim 1, wherein the processor is configured to:
receive inclination information of the plurality of wireless power receivers, and
detect the first wireless power receiver based on the inclination information of the plurality of wireless power receivers.

7. The wireless power transmitter of claim 1, wherein the processor is configured to:
receive information about priorities of the plurality of wireless power receivers from the master wireless power receiver,
calculate required power for each of plurality of wireless power receivers based on the priority information, and
send information about the calculated required power to each of the plurality of wireless power receivers.

8. The wireless power transmitter of claim 1, wherein the processor is configured to:
obtain information about priorities of the plurality of wireless power receivers from the master wireless power receiver, and
control transmission power of the resonant coil based on the priority information.

9. The wireless power transmitter of claim 1, wherein the processor is configured to, when a second wireless power receiver being inclined to the plate or making a preset motion above the plate is detected after the first wireless power receiver is detected:
identify a wireless power receiver having a display of a larger size as the master wireless power receiver among the first wireless power receiver and the second wireless power receiver.

10. The wireless power transmitter of claim 1, wherein the processor is configured to, when a second wireless power receiver being inclined to the plate or making a preset motion above the plate is detected after the first wireless power receiver is detected:
receive location information of a user from the first wireless power receiver and the second wireless power receiver, and
identify a wireless power receiver located closer to the user as the master wireless power receiver among the first wireless power receiver and the second wireless power receiver.

11. The wireless power transmitter of claim 1, wherein the processor is configured to, when a second wireless power receiver being inclined to the plate or making a preset motion above the plate is detected after the first wireless power receiver is detected:
identify the first wireless power receiver associated with a first user as a first master wireless power receiver for indicating a state of charge of a wireless power receiver associated with the first user among the plurality of wireless power receivers, and
identify the second wireless power receiver associated with a second user as a second master wireless power receiver for indicating a state of charge of a wireless power receiver associated with the second user among the plurality of wireless power receivers.

12. The wireless power transmitter of claim 1, wherein the processor is configured to identify the first wireless power receiver as the master wireless power receiver even based on the first wireless power receiver determined as not being inclined to the plate after the first wireless power receiver is identified as the master wireless power receiver.

13. The wireless power transmitter of claim 1, wherein the processor is configured to:
transmit, to a second wireless power receiver, a command signal to provide an interface for designating the second wireless power receiver as the master wireless power receiver in response to establishment of communication connection with the second wireless power receiver through the short-range communication module,
receive a first signal transmitted from the second wireless power receiver, and
identify the second wireless power receiver as the master wireless power receiver in response to receiving the first signal,
wherein the first signal is transmitted in response to the second wireless power receiver receiving a user input to designate the second wireless power receiver as the master wireless power receiver.

14. A method of controlling a wireless power transmitter, the method comprising:
detecting a first wireless power receiver being inclined to a plate or making a preset motion above the plate among a plurality of wireless power receivers receiving power from a resonant coil;
identifying the first wireless power receiver as a master wireless power receiver to indicate states of charge of the plurality of wireless power receivers; and
sending the first wireless power receiver a signal indicating that the first wireless power receiver is identified as the master wireless power receiver.

15. The method of claim 14, wherein the detecting of the first wireless power receiver comprises:
receiving information about amounts of received power of the plurality of wireless power receivers;
determining coupling coefficient values between the plurality of wireless power receivers and the resonant coil based on the amounts of received power of the plurality of wireless power receivers and an amount of transmitted power of the resonant coil; and
detecting the first wireless power receiver based on the coupling coefficient values.

16. A method of controlling a wireless power transmitter, the method comprising:
recognizing that wireless power receivers receive power from a coil;
detecting that a portion of the wireless power receivers are inclined or are making a preset motion;
identifying each wireless power receiver of the portion as a master wireless power receiver to indicate states of charge of the wireless power receivers; and
sending each wireless power receiver of the portion a signal indicating that each wireless power receiver of the portion is identified as the master wireless power receiver.

17. The method of claim 16, wherein the detecting of the portion comprises:
receiving information about amounts of received power of the wireless power receivers;
determining coupling coefficient values between the wireless power receivers and the coil based on the amounts of received power of the wireless power receivers and an amount of transmitted power of the coil; and
detecting the portion based on the coupling coefficient values.

18. The method of claim 16, wherein:
the identifying of each wireless power receiver of the portion as a master wireless power receiver comprises establishing priorities of each wireless power receiver of the portion,
the method further comprises sending each wireless power receiver of the portion an additional signal indicating the priorities, and
each wireless power receiver of the portion assumes master wireless power receiver status in a sequence according to the priorities.

19. The method of claim 16, wherein:
the identifying of each wireless power receiver of the portion comprises:
grouping each wireless power receiver not in the portion in sub-groups; and
establishing each wireless power receiver of the portion as the master wireless power receiver for one of the sub-groups, and
the signal sent to each wireless power receiver of the portion indicates that each wireless power receiver of the portion is identified as the master wireless power receiver for the one of the sub-groups.
